(19) United States
(12) Patent Application Publication
(10) Pub. No.: US 2007/0039444 A1
(43) Pub. Date: Feb. 22, 2007

(54) Cutting mechanism for an installation for producing extruded plastic or laminated tubes

(76) Inventor: Walter Breyer, Worblingen (DE)

Correspondence Address: BACHMAN & LAPOINTE, P.C., 900 CHAPEL STREET, SUITE 1201, NEW HAVEN, CT, 06510, US

(21) Appl. No.: 10/593,528

(22) PCT Filed: Feb. 28, 2005
(86) PCT No.: PCT/EP05/02100

§ 371 Date: Oct. 10, 2006

(30) Foreign Application Priority Data
Mar. 19, 2004 (DE) 102004013993.8

(51) Int. Cl. B26D 1/60

(52) U.S. Cl. 83/734; 83/350

(57) ABSTRACT

A cutting system for an installation (A) for producing extruded plastic or laminated tube pipes. A cutting device has a cradle that can be reciprocated relative to a base and on top of which the cutting device rests. The system is characterized in that the cradle on which the cutting device rests is configured as a linear motor and can be displaced relative to the base.

### CROSS REFERENCE TO RELATED APPLICATIONS

This case is the U.S. national phase of International Application No. PCT/EP2005/002100 filed Feb. 28, 2005 which claims priority of German Application No. 10 2004 013 993.8 filed Mar. 19, 2004.

### BACKGROUND OF THE INVENTION

The present invention relates to a cutting mechanism for an installation for producing extruded plastic or laminated tubes with a carriage which can be moved back and forth with respect to a base and on which a cutting device is mounted.

Conventional cutting mechanisms for installations for producing extruded plastic or laminated tubes are known on the market and customary in various forms and configurations. They serve in particular for continuously cutting off tubes or the like in an extrusion production process, a movement of the cutting mechanism being adapted to the delivery rate or speed of the extruded tube, and the cutting-off operation being performed when they coincide. Subsequently, the cutting mechanism is moved back counter to the direction of movement of the extruded tube and synchronized with the delivery rate of the tube for renewed cutting-off. Various cutting mechanisms can be used for this.

A disadvantage here is that, in the case of small tube lengths that are to be cut off, the cutting device has to be operated at very high stroke rates or speeds to cut them off. This rapid back and forth movement of the cutting device is no longer possible with conventional spindle-operated cutting devices. The mechanical loads are too high; the cutting devices therefore cannot be operated at high speeds.

The present invention is based on the object of providing a cutting mechanism of the type mentioned at the beginning which overcomes the disadvantages mentioned, with which a carriage with a mounted cutting device can be moved back and forth at significantly higher speeds for cutting off tubes in a simple, exact, precise and low-cost way.

### SUMMARY OF THE INVENTION

The foregoing object is achieved by providing a cutting mechanism for an installation (A) for producing extruded plastic or laminated tubes with a carriage which can be moved back and forth with respect to a base and on which a cutting device is mounted, characterized in that the carriage with the mounted cutting device is formed as a linear motor and is movable with respect to the base. The object is further achieved by providing a cutting mechanism for an installation (A) for producing extruded plastic or laminated tubes with a carriage which can be moved back and forth with respect to a base and on which a cutting device is mounted, characterized in that a linear back and forth movement of the carriage, formed as a linear motor, with respect to the base can be controlled and/or regulated as the slave by means of a transporting mechanism, arranged upstream of the cutting device, as the master.

In the case of the present invention, it has proven to be particularly advantageous to connect a carriage to a base by means of at least one linear guide, preferably by means of dovetail-like connections, one or a plurality of permanent magnets, arranged next to one another, being provided or inserted in the carriage, preferably in the region of the underside and centrally between the linear guides.

The permanent magnets are preferably inserted in an underside of the carriage over its full length, next to one another and slightly spaced apart.

However, it is also intended to be within the scope of the present invention for only one or a plurality of permanent magnets to be used as standard magnets.

Moreover, it is conceivable to provide the permanent magnet/coil arrangement in the reverse arrangement, i.e. the coil is provided in the carriage and the at least one permanent magnet is then arranged in the base. This is likewise intended to be within the scope of the present invention.

It is important in the case of the present invention that at least one coil is inserted or provided in the base, underneath the permanent magnets of the carriage, which coil, allowing itself to be actively activated, causes a movement of the carriage back and forth, depending on the control of the corresponding voltages.

As a result, very high masses can be accelerated back and forth with very high accelerations, since in particular the cutting device is a sophisticated apparatus. In this way it is possible to operate with very many cycles, comprising two strokes, up to for example 550 to 650 per minute in the case of short strokes, so that part of the extruded tube can be cut off every back and forth motion by means of the cutting device mounted on the carriage in a synchronized movement.

In order to ensure synchronization, it has proven to be particularly advantageous in the case of the present invention for the transporting device that is arranged upstream of the cutting mechanism to form the master control and the actual cutting device or the carriage with the base as the linear motor to form the so-called slave.

In this way it is possible during the continuous extrusion for the speed of the cutting device to be adapted to the delivery rate of the tube to be cut off and, when there is synchronization, the tube can then be cut to length correspondingly to any desired length.

Furthermore, it has proven to be particularly advantageous to provide in particular magnetic tracks inside and/or outside the respective linear guides, in order to move the carriage back and forth with respect to the base with reduced friction, preferably without any contact.

Furthermore, it is intended to be within the scope of the present invention that, for example, the carriage of the cutting mechanism is covered inside a machine housing by means of shutters, in order to avoid risk of injury.

Furthermore, corresponding stops and buffer elements are provided on the carriage and the base, in order to arrest undesired end position transgressions, incremental or inductive length measuring systems also being provided between the carriage and the base or the carriage and the linear guide, in order to ensure an exact position of the carriage, and consequently also an exact length when cutting off a plastic or laminated tube, or in order to move exactly to individual positions.

It is important, however, in the case of the present invention that very high speeds of the carriage with a mounted cutting device are possible, so that altogether not only the extrusion rate but also the number of tubes to be cut off can be increased with extremely low maintenance effort and low downtimes.

### BRIEF DESCRIPTION OF THE DRAWINGS

Further advantages, features and details of the invention emerge from the description which follows of preferred exemplary embodiments and with reference to the drawing, in which:

FIG. 1 shows a schematically represented installation for producing extruded plastic or laminated tubes with a cutting mechanism according to the invention;

FIG. 2 shows a schematically represented side view of part of the cutting mechanism, comprising a cutting device, a carriage and a base;

FIG. 3 shows a schematically represented side view of the cutting mechanism according to the invention as shown in FIG. 2;

FIG. 4 shows a schematically represented plan view of the carriage and the base of the cutting mechanism, without a cutting device.

### DETAILED DESCRIPTION

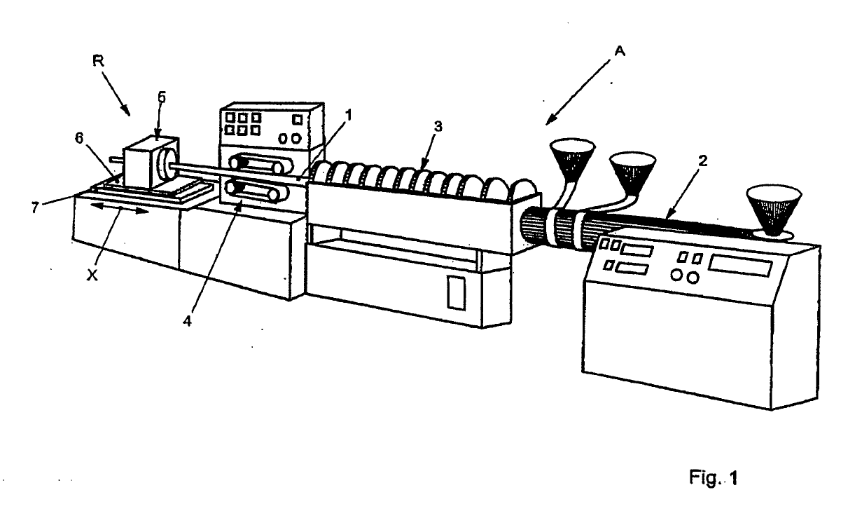

As shown in FIG. 1, an installation A according to the invention for producing extruded plastic or laminated tubes 1, only indicated here, has an extruder 2, in which plastics material, likewise provided with additives, is extruded under the effect of heat. In a pipe die head (not represented in any more detail here), the material is then formed into a tube and cooled, shaped and surface-treated in a calibrator 3, the plastic or laminated tube, referred to hereafter as tube 1, being fed to a transporting mechanism 4 once it emerges.

The transporting mechanism 4 continuously feeds an extruded tube 1 to the cutting mechanism R according to the invention. The cutting mechanism R is formed substantially by a cutting device 5, which is on a carriage 6, which can be moved back and forth with respect to a base 7, as represented in the direction of the double-headed arrow X.

The operating mode of the cutting mechanism R is as follows:

The transporting mechanism 4 evens out a delivery rate of the tube 1, which is introduced into a cutting device 5. After introducing the tube 1 to a desired length that is to be cut off, the cutting device 5 is moved along with the tube 1 while the latter enters it, is adapted to the delivery rate of the tube 1 and cutting-off is performed during this synchronization.

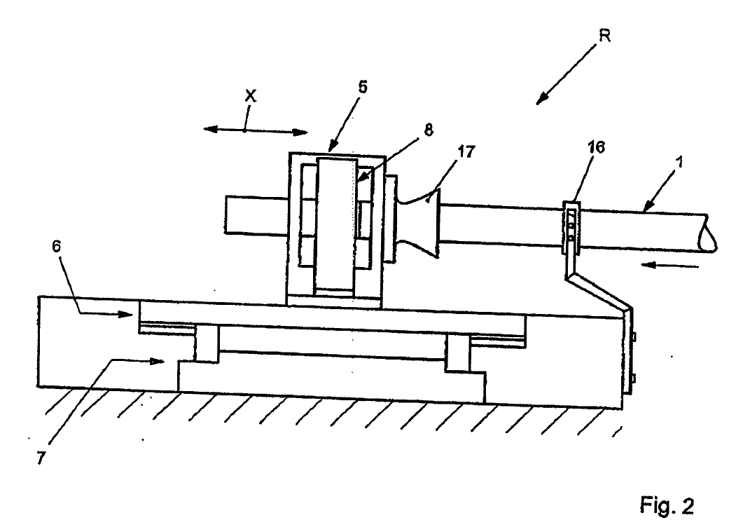

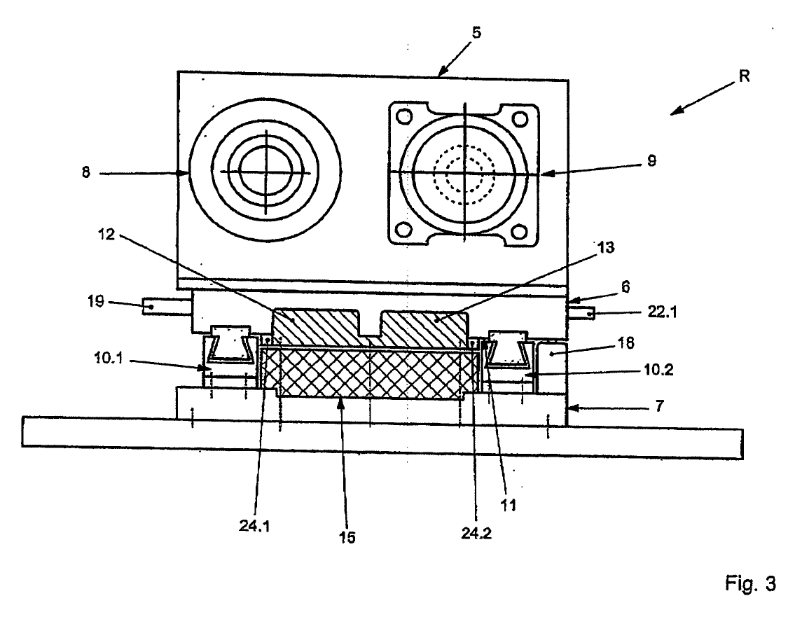

In order that this operation can take place very quickly, so that it is possible to operate at higher delivery and extrusion rates, it has proven to be particularly advantageous in the present invention, as it is presented in particular in FIGS. 2 and 3, to mount the cutting device 5 on the carriage 6. In this case, the cutting device 5 is formed by an indicated knife unit 8 and a motor, preferably a servo motor 9. The servo motor 9 drives the knife unit 8 for driving a rotating knife (not represented in any more detail here) for severing the tube 1 into individual pieces. The severing of the tube 1 takes place during the movement of the cutting device 5 in the tube transporting direction, with a synchronized identical speed. With this cutting time increment, the speed of the cutting device 5 is synchronized with the movement of the tube 1 or the extrusion rate.

In the exemplary embodiment of the present invention as shown in FIG. 3, the carriage 6 is guided in such a way that it can be moved linearly back and forth with respect to the base 7, by means of preferably two linear guides 10.1, 10.2 spaced apart parallel to each other, as indicated in FIG. 2 in the direction of the double-headed arrow X.

The linear guides 10.1, 10.2 may have dovetail-like guiding rails, so that only exact linear guidance of the movable carriage 6 with respect to the preferably fixed base 7 is possible.

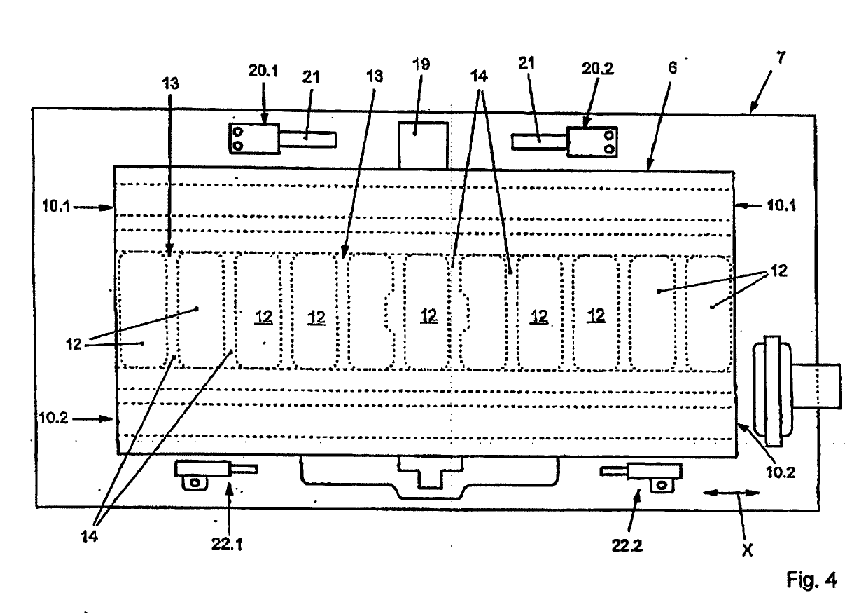

In the present invention it has proven to be particularly advantageous, in order to ensure very high accelerations of the carriage 6, and consequently also of the cutting device 5 mounted on it, that in the region of an underside 11 of the carriage 6, as indicated by dashed lines in the exemplary embodiment as shown in FIG. 4, a plurality of permanent magnets 12 are inserted next to one another in the carriage 6, preferably over its full length, in particular into individual recesses 13 provided for this, as indicated in FIG. 3.

The recesses 13, and the permanent magnets 12 inserted inthem, are preferably aligned perpendicularly in relation to the linear guides 10.1, 10.2, the entire space between the two linear guides 10.1, 10.2 serving to reduce the dead weight. The at least one permanent magnet 12 is mounted in the region of the recesses 13 of the carriage 6, preferably between the linear guides 10.1, 10.2.

Webs 14 may be formed between the respective individual permanent magnets 12 in order to increase the stability of the carriage 6 while maintaining a low dead weight.

It is also important in the case of the present invention that at least one coil 15, which can be actively activated, is provided between the linear guides 10.1, 10.2 of the base 7, in order to accelerate the carriage 6 back and forth with respect to the base 7 in the represented direction of the double-headed arrow X.

In this way it is possible to operate strokes or individual strokes at very high rates according to choice, in order for example to get into ranges of 550 to 650 individual strokes per minute. This means that approximately up to 250 to 550, preferably 300, cuts per minute of the extruded tube 1 are possible. In this way, high numbers of plastic or laminated tubes can be cut off in an extremely short time.

Guided by means of the transporting mechanism 4 and by means of a guiding sleeve 16, which is connected to the base 7, the tube 1 is fed to a centering piece 17 of the knife unit 8.

In order in particular to ensure synchronization of the speed, in particular the complete sequence of movements of the cutting device 5 or of the carriage 6, the carriage 6 is controlled or regulated by the transporting mechanism 4, arranged upstream of the cutting mechanism R, as the master over the base 7 by means of the at least one coil 15 as the so-called slave.

In order to optimize regulation, assigned to the base 7 and/or the linear guides 10.1, 10.2 is an incremental or inductive length measuring system 18, which continuously determines the movement of the carriage 6, and consequently of the cutting device 5, with respect to the base 7 in an incremental or inductive manner.

Also assigned to the carriage 6, as indicated in particular in FIG. 4, is a stop 19, which interacts in the respective end positions with possibly adjustable or settable buffer elements 20.1, 20.2, which are connected to the base 7. The buffer elements 20.1, 20.2 are, for example, provided with corresponding spring damper elements 21, which interact with the stop 19 if a predetermined end position is transgressed.

Preferably assigned laterally to the base 7, opposite the stop 19, are inductive proximity switches 22.1, 22.2, which serve for zero-point determination in a reference run of the carriage 6.

1-16. (canceled)

17. A cutting mechanism for an installation (A) for producing extruded plastic or laminated tubes (2) comprising a carriage (6) which can be moved back and forth with respect to a base (7), a cutting device (5) mounted on the carriage (6), wherein the carriage (6) with the mounted cutting device (5) is formed as a linear motor and is movable with respect to the base (7).

18. A cutting mechanism for an installation (A) for producing extruded plastic or laminated tubes (2) comprising a carriage (6) which can be moved back and forth with respect to a base (7), a cutting device (5) mounted on the carriage (6) comprising a linear motor, wherein a linear back and forth movement of the carriage (6) with respect to the base (7) is controlled and/or regulated as the slave by means of a transporting mechanism (4) which is arranged upstream of the cutting device (5), as the master.

19. The cutting mechanism as claimed in claim 17 or 18, wherein the carriage (6) is moved back and forth with respect to a base (7) in a linear direction by means of at least one linear guide (10.1, 10.2).

20. The cutting mechanism as claimed in claim 19, wherein the carriage (6) is mounted in such a way that it can be moved linearly with respect to the base 7, by means of two linear guides (10.1, 10.2) arranged parallel to each other.

21. A cutting mechanism as claimed in claim 19, wherein the carriage (6) is assigned at least one permanent magnet (12).

22. The cutting mechanism as claimed in claim 21, wherein a plurality of permanent magnets (12) are arranged between two linear guides (10.1, 10.2) in the region of an underside (11) of the carriage (6).

23. The cutting mechanism as claimed in claim 21, wherein a plurality of permanent magnets (12) are arranged in the region of the underside (11) of the carriage (6), and are spaced apart from one another over the full length of the carriage (6).

24. The cutting mechanism as claimed in claim 23, wherein at least one activatable coil (15) is provided in the base (7).

25. The cutting mechanism as claimed in claim 24, wherein the at least one coil (15) is located between the linear guides (10.1, 10.2) and is assigned to the base (7), the at least one coil (15) is arranged near the permanent magnets (12) of the carriage (6) between the linear guides (10.1, 10.2).

26. The cutting mechanism as claimed in claim 19, wherein at least one activatable coil (15) is provided in the region of an underside (11) of the carriage (6) and at least one permanent magnet (12) is provided in the base (7), wherein the coil and the magnet interact with each other.

27. The cutting mechanism as claimed in claim 19, wherein the cutting device (5) is formed by a rotating knife unit (8) and at least one servo motor (9), and the knife unit (8) has a centering piece (17) at one end and a guiding sleeve (16) arranged upstream of the centering piece (17).

28. The cutting mechanism as claimed in claim 19, wherein the carriage (6) has a stop (19) and interacts in an end position with two buffer elements (20) which are spaced apart, assigned to the base (7) and formed as spring damper elements (21).

29. The cutting mechanism as claimed in claim 19, wherein the base (7) is assigned two spaced apart inductive proximity switches (22.1, 22.2) which serve as a zero-point determination during a reference running time of the carriage (6).

30. The cutting mechanism as claimed in claim 19, wherein linear movement of the carriage (6) with respect to the base (7) can be regulated and controlled by means of a linear guide (10.1, 10.2) and is activated by means of the at least one coil (15) assigned to the base (7), with regard to acceleration, negative acceleration and with regard to the maximum deflection.

31. The cutting mechanism as claimed in claim 30, wherein the carriage (6) can be moved back and forth with respect to the fixed base (7) virtually without any contact in an actively driven manner over at least one magnetic track (24.1, 24.2), which is provided inside or outside the linear guides (10), parallel to the latter.

32. The cutting mechanism as claimed in claim 31, wherein the base (7) and/or the linear guide (10.1, 10.2) is assigned an incremental or inductive length measuring system (18), which interacts with the carriage (6) for exact positional determination, it being possible by means of this positional determination for the speed of the carriage (6) to be determined and regulated.
